(19) United States
(12) Patent Application Publication
(10) Pub. No.: US 2004/0111862 A1
(43) Pub. Date: Jun. 17, 2004

(54) Backup tool for use with a rivet and method of use

(76) Inventors: Carl B Rooney, Middleton Machester (GB); Graham Mansey, Middleton Machester (GB); Ian W Milne, Middleton Machester (GB)

Correspondence Address: NIXON & VANDERHYE, PC, 1100 N GLEBE ROAD, 8TH FLOOR, ARLINGTON, VA, 22201-4714, US

(21) Appl. No.: 10/475,745

(22) PCT Filed: Aug. 23, 2002
(86) PCT No.: PCT/GB02/03893

(30) Foreign Application Priority Data
Sep. 5, 2001 (GB) 0121423.8

(51) Int. Cl. B27F 7/17; B23P 11/00

(52) U.S. Cl. 29/509; 227/1; 29/524.1

(57) ABSTRACT

Described herein is a bucking tool (10) for retaining a burr washer in place whilst a rivet is reacted. The tool (10) comprises a sleeve (12) with a shaft (14) slidably mounted within it. The sleeve (12) has a recess (22) formed at one end (20) for receiving the washer. The shaft (14) has a handle (16) attached at one end (18), the handle (16) being operable to move the shaft (14) in a longitudinal direction within the sleeve (12).

The present invention relates to improvements in or relating to riveting tools.

It is often desired that a burr washer be fitted to one side of a rivet. However, it is often difficult to fit and secure burr washers in place whilst reacting the rivet:

It is an object of the present invention to provide a riveting tool which overcomes the problem described above.

In accordance with one aspect of the present invention, there is provided a tool for use with a rivet, the tool comprising a sleeve portion having a recess at one end and a shaft slidably located within the sleeve portion, the recess being operable to retain a washer as the rivet is reacted.

In accordance with a second aspect of the present invention, there is provided a method of reacting a rivet, the method comprising the steps of:—

a) inserting the rivet into a hole formed in an object;

b) inserting a washer into a tool as described above;

c) placing the tool and washer against a surface of the object surrounding the hole so that a portion of the rivet extends into the washer;

d) reacting the rivet and retaining the washer; and

e) separating the washer from the tool using the shaft of the tool.

For a better understanding of the present invention, reference will now be made, by way of example only, to the accompanying drawings in which:—

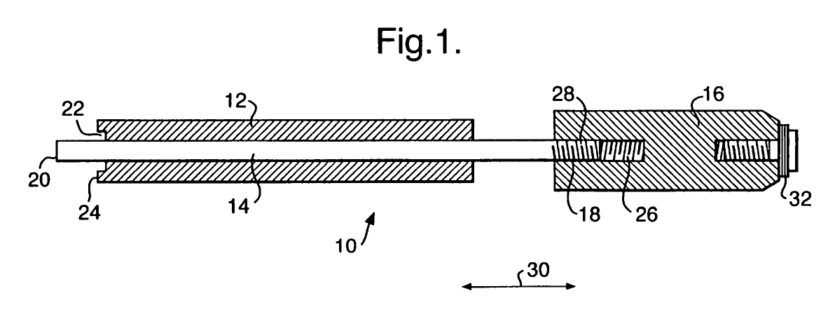

FIG. 1 is a schematic sectional view through a tool in accordance with the present invention, and

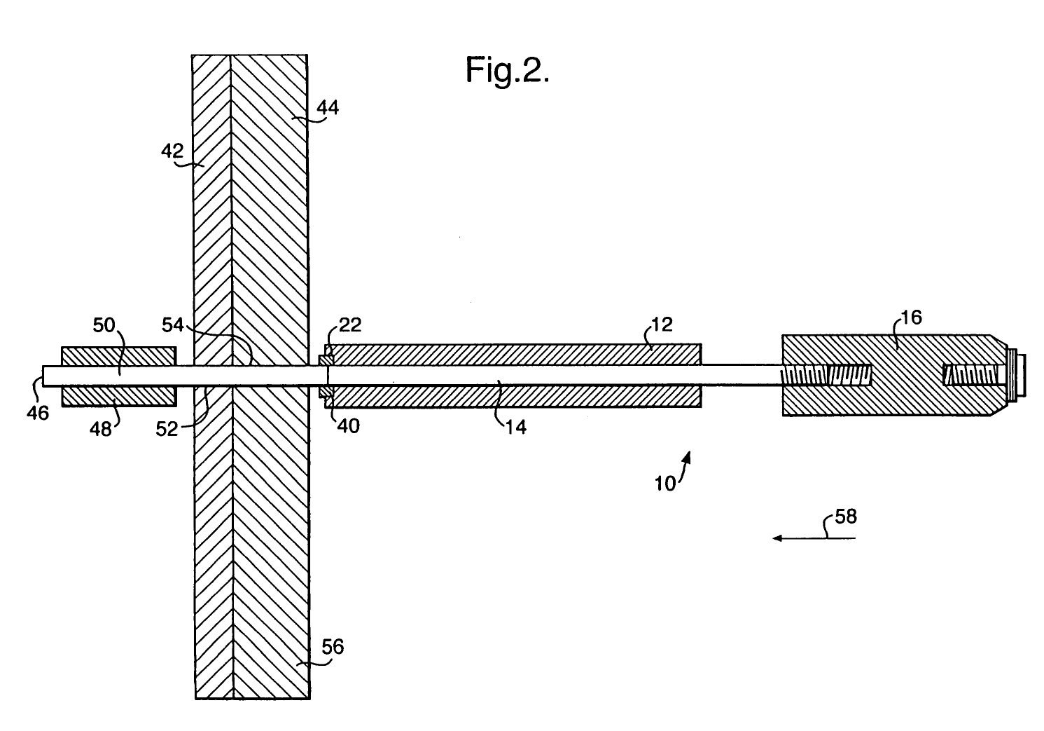

FIG. 2 is a schematic sectional view illustrating the operation of the tool in accordance with the present invention.

Referring initially to FIG. 1, a tool 10 in accordance with the present invention is shown. The tool 10 comprises a sleeve 12 in which a shaft 14 is located. The shaft 14 is slideable within the sleeve 12 and carries a handle 16 at one end 18. The other end 20 of the shaft 14 is free. A recess 22 is formed in one end 24 of the sleeve 12 for accommodating a burr washer (not shown). The handle 16 has a tapped hole 26 which allows a threaded portion 28 at end 18 of the shaft 14 to be screwed into it. Movement of the handle 16 in the directions shown by arrow 30 when the sleeve 12 is retained moves the shaft 14 within the sleeve 12.

Although not shown in FIG. 1, it will be appreciated the extent of movement of the shaft 14 within the sleeve 12 is such that end 20 of the shaft 14 can extend beyond end 24 of the sleeve 12 as shown or can be retracted within the sleeve 12 (not shown).

The handle 16 may be of any suitable shape and in this particular embodiment carries a bolt and washer arrangement 32.

The sleeve 12 may be manufactured from aluminium bar or tubing and the shaft 14 may be manufactured from silver steel bar. Naturally, these components may also be manufactured from any other suitable material.

Turning to FIG. 2, operation of the tool 10 will now be described. Tool 10 is shown with a burr washer 40 located in recess 22. In this case, end 20 of shaft 14 does not extend into recess 22. Two pieces 42, 44 of material are to be joined by rivet 46 which comprises a sleeve 48 and a pin 50. As is usual, holes 52, 54 are respectively formed in the material pieces 42, 44 for receiving the rivet pin 50 as shown. The tool 10 is moved up to surface 56 of material piece 44 so that the burr washer 40 is located on the free end of pin 50, such that the pin 50 extends into the sleeve 12. With the tool 10 against surface 56, the rivet 46 is reacted so that the two pieces 42, 44 of material are joined together with the burr washer 40 in place against surface 56.

Once the rivet 46 is reacted, handle 16 is pushed towards surface 56 in the direction indicated by arrow 58 whilst retaining sleeve 12 so as to move the tool 10 away from surface 56 whilst leaving burr washer 40 in place.

It will be understood that sleeve 12 of tool 10 acts as a reaction surface for the rivet 46 whilst holding burr washer 40 in place.

1. A tool for use with a rivet, the tool comprising a sleeve portion having a recess at one end and a shaft slidably located within the sleeve portion, the recess being operable to retain a washer as the rivet is reacted.

2. A tool according to claim 1, wherein the shaft is operable to separate the washer from the sleeve after the rivet is reacted.

3. A tool according to claim 1 or 2, wherein the shaft includes a handle at its end remote from the recess.

4. A method of reacting a rivet, the method comprising the steps of:—
a) inserting the rivet into a hole formed in an object;
b) inserting a washer into a tool according to any one of claims 1 to 3;
c) placing the tool and washer against a surface of the object surrounding the hole so that a portion of the rivet extends into the washer;
d) reacting the rivet and retaining the washer; and
e) separating the washer from the tool using the shaft of the tool.

5. A tool for use with a rivet substantially as hereinbefore described with reference to the accompanying drawings.

6. A method of reacting a rivet substantially as hereinbefore described with reference to FIG. 2 of the accompanying drawings.
